(19) United States
(12) Patent Application Publication
(10) Pub. No.: US 2014/0333717 A1
(43) Pub. Date: Nov. 13, 2014

(54) APPARATUS AND METHOD FOR IMAGE PROCESSING OF VEHICLE

(71) Applicant: Hyundai Motor Company, Seoul (KR)

(72) Inventors: Dongsoo SHIN, Suwon-si (KR); Sung Un KIM, Yongin-si (KR)

(73) Assignee: HYUNDAI MOTOR COMPANY, Seoul (KR)

(21) Appl. No.: 14/144,954

(22) Filed: Dec. 31, 2013

(30) Foreign Application Priority Data
May 10, 2013 (KR) 10-2013-0053010

(51) Int. Cl. G06K 9/00; H04N 5/232

(52) U.S. Cl. CPC G06K 9/00832; H04N 5/23238
USPC 348/36

(57) ABSTRACT

An image processing apparatus includes a lighting switch turned on or off based on a control signal input from an outside thereof to selectively radiate light to an object of a recognition target. A first diffuser is connected to the lighting switch and spreads the light radiated from the lighting switch to the object. An image collector collects a first image of the object in a turned-on state of the lighting switch and collects a second image of the object in a turned-off state of the lighting switch. An image processor obtains a panoramic image by subtracting the second image from the first image, and thereby recognizing a gesture of the object.

### CROSS-REFERENCE TO RELATED APPLICATION

This application claims the benefit of priority to Korean Patent Application No. 10-2013-0053010 filed in the Korean Intellectual Property Office on May 10, 2013, the entire contents of which are incorporated herein by reference.

### TECHNICAL FIELD

The present disclosure is related to an apparatus and method for image processing of a vehicle, and more particularly, to an apparatus and method for image processing of a vehicle having advantages of extracting a panorama without complex image processing.

### BACKGROUND

When an image, such as a driver's gesture or driver monitoring in a vehicle is recognized through image processing, it is necessary to eliminate a background other than a recognition object (i.e., a panorama, hands, face, or the like) from the image. When the background is eliminated from the image, it is possible to monitor the recognition object only. Therefore, a recognition performance can be acquired.

As described, elimination of the background from the image is an important process, but it is difficult to separate the recognition object from the background because of brightness, color, or texture of the background. Further, many system resources are necessary to eliminate the background image by using a pure image processing method, thus increasing the cost.

The above information disclosed in this Background section is only for enhancement of understanding of the background of the disclosure and therefore it may contain information that does not form the prior art that is already known in this country to a person of ordinary skill in the art.

### SUMMARY

The present disclosure provides an apparatus and a method for image processing of a vehicle having advantages of extracting a panorama without complex image processing.

An image processing apparatus according to an exemplary embodiment of the present disclosure includes a lighting switch turned on or off based on a control signal input from an outside thereof to selectively radiate light to an object of a recognition target. A first diffuser is connected to the lighting switch and spreads the light radiated from the lighting switch to the object. An image collector collects a first image of the object in a turned-on state of the lighting switch and collects a second image of the object in a turned-off state of the lighting switch. An image processor obtains a panoramic image by subtracting the second image from the first image, and thereby recognizing a gesture of the object.

The image processing apparatus further includes a second diffuser installed to the image collector, receiving the light when the light is reflected from the object and eliminating an image existing at an outside of a recognition region of the image collector. A filter is installed between the image collector and the second diffuser and increases resolution of the image decreased by the second diffuser.

The image processing apparatus further includes a lighting controller controlling the lighting switch to be turned on or off based on the control signal generated by the image processor.

An image processing method by an image processing apparatus according to another embodiment of the present disclosure includes radiating a light to a recognition object according to a control signal. A first image of the object is obtained when the light is radiated to the object. The light is turned off according to the control signal, and a second image of the object is obtained. A panoramic image is obtained based on the first image and the second image, and a gesture of the object is recognized from the obtained panoramic image.

The panoramic image is obtained by eliminating the second image from the first image while obtaining the panoramic image.

According to the present disclosure, with a low material cost and a simple configuration, a high resolution panoramic image can be acquired without a complex image processing procedure in a vehicle

Since processing power can be reduced, a low cost processor can be used, and a background image can be efficiently eliminated, the recognition performance is improved.

### BRIEF DESCRIPTION OF THE DRAWINGS

FIG. 1 shows a general process of image recognition according to the prior art.

FIG. 2 shows another general process of image recognition according to the prior art.

FIG. 3 shows a diagram for configuring an image processing apparatus according to an exemplary embodiment of the present disclosure.

FIG. 4 shows an image processing apparatus according to an exemplary embodiment of the present disclosure.

FIG. 5 shows a flowchart of an image processing method according to an exemplary embodiment of the present disclosure.

FIG. 6 shows an exemplary view in which a background image is eliminated according to an exemplary embodiment of the present disclosure.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout this specification and claims which follows, unless explicitly described to the contrary, the word “comprise” and variations such as “comprises” or “comprising” will be understood to imply the inclusion of stated elements but not the exclusion of any other elements.

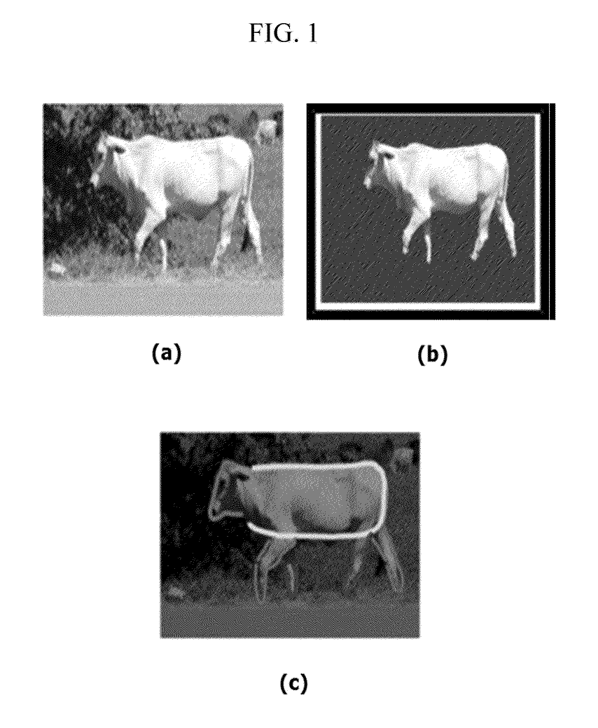

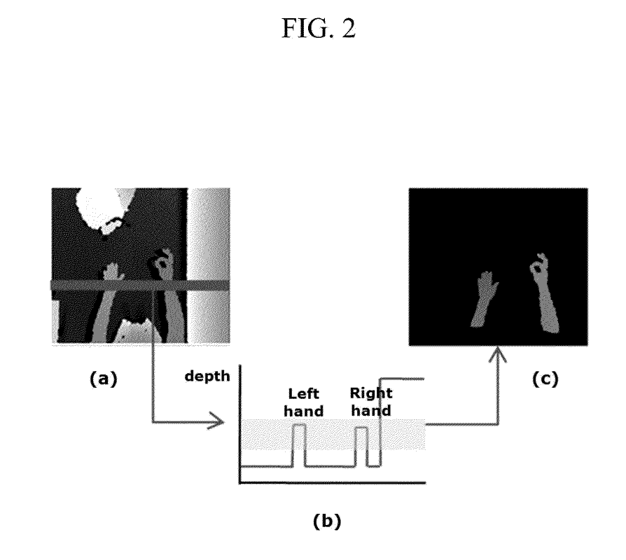

Hereinafter, an image processing apparatus and method for a vehicle according to an exemplary of the present disclosure is described with reference to the drawings. A general process of image recognition will now be described with reference to FIG. 1 and FIG. 2 before describing an exemplary embodiment of the present disclosure.

FIG. 1 shows a general process of image recognition according to the related art, and FIG. 2 shows another general process of image recognition.

FIG. 1 shows a general process of image recognition using a general two-dimensional camera. When an image photographed by a general two-dimensional camera is acquired as shown in FIG. 1(a), the background is eliminated from the image as shown in FIG. 1(b). Thereby, a panoramic image is extracted from the image as shown in FIG. 1(c) using the following two methods. The first method is to eliminate the background image using pixel information (e.g., brightness or color), and the second method is to limit the environment (e.g., to photograph in a studio or to install a blackout screen).

When the first method is used, a calculation amount is increased, such that a more expensive processor is needed. Further, it is not possible to fully separate the background according to characteristics of pixel information. In case of using the second method, it is possible to eliminate background completely, but the environmental limitation is increased, such that it is difficult to apply to an outdoor or vehicle surroundings.

FIG. 2 shows another general process of image recognition using a three-dimensional camera. As shown in FIG. 2, when using a three-dimensional camera, a depth map can be acquired as shown in FIG. 2(a), thereby the background is easily eliminated.

That is, when the object is photographed using the three-dimensional camera as shown in FIG. 2(a), a depth map image, that becomes lighter as a distance to the object is decreased and becomes darker as a distance to the object is increased, is acquired. When the depth map of the red line part of FIG. 2(a) is displayed in a graph, it can be displayed as shown in FIG. 2(b). Herein, when the image is filtered by only depth regions of the left and right, a region having depth near the hands can be acquired as shown in FIG. 2(c).

However, if a stereo camera is used, a much larger amount of calculation is needed to acquire the depth map. In case of using a Kinect or time-of-fight (TOF) camera, additional calculation is not necessary to acquire the depth map. However the three-dimensional camera is expensive, and thereby, it is difficult to configure a system.

According to an exemplary embodiment of the present disclosure, an image processing apparatus using a diffuser and method thereof will be described.

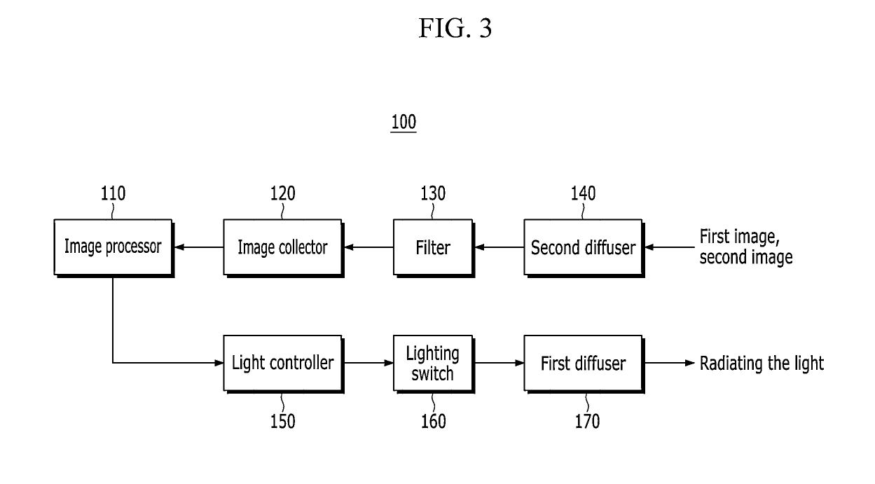

FIG. 3 shows a diagram for configuring an image processing apparatus according to an exemplary embodiment of the present disclosure. As shown in FIG. 3, an image processing apparatus 100 according to an exemplary embodiment of the present disclosure includes an image processor 110, a light controller 150, an image collector 120, a filter 130, a first diffuser 170, a second diffuser 140, and a lighting switch 160.

The light controller 150 controls light to be turned on/off in the lighting switch 160 to be described later. According to an exemplary embodiment of the present disclosure, the light controller 150 receives signals for controlling the lighting switch 160 from the image processor 110, but it is not limited thereto. That is, the light controller 10 controls the lighting switch 160 based on signals which include predetermined information for turning on the light at a predetermined time after the image collector 120 is activated to collect an image and the predetermined information for turning off the light at the predetermined time after the light is turned on.

The image collector 120 collects the first image of the object while the light is radiated and collects the second image of the object while the light is turned off. Here, the case in which the two-dimensional camera is used in the image collector 120 will be described as an example, but it is not limited thereto.

The filter 130 is provided between the image collector 120 and second diffuser 140. The filter 130 outputs a high resolution image of the object while resolution is decreased through the second diffuser 140. That is, when the second diffuser 140 is installed to the image collector 120, the resolution is decreased. Particularly, as the distance to the object is increased, the resolution is decreased. To increase the resolution, a filter 130 is disposed to the image collector 120. Various types of filters 130 can be used, and an exemplary embodiment of the present disclosure is not limited to a specific type.

The second diffuser 140 is disposed to the image collector 120 and disposed adjacent the filter 130.

When the light from the lighting switch 160 to be described is reflected from a recognition object, the image collector 120 receives the reflected light, and the image existing outside of the recognition region is blurred and eliminated.

The image processor 110 confirms the operation of the image collector 120, generates a control signal, and transmits the control signal to the light controller 150. There may be many methods for confirming the operation of the image collector 120. In an exemplary embodiment of the present disclosure, they are not limited to a specific method.

The image processor 110 processes an image collected by the image collector 120 with improved resolution, and thereby recognizing the image or gesture of the object. A panoramic image, that is the object, is acquired by eliminating the second image from the first image. Here, the second image is acquired while the lighting switch 160 is on, and the first image is acquired while the lighting switch 160 is off. The image processor 110 recognizes the image or gesture of the object from the acquired panoramic image.

The first diffuser 170 is disposed to the lighting switch 160 and evenly spreads the light radiated from the lighting switch 160. That is, the first diffuser 170 increases the diffusion effect of the light. The light radiated by the lighting switch 160 is a straight line or circular cone light with a narrow width. In this case, the light is only radiated to a predetermined area. A recognition region, which is recognized by the image collector 120 with the narrow width, decreases the image quality, so the first diffuser 170 installed to the lighting switch 160 is used to make light radiated by the lighting switch 160 evenly spread to the object.

In order to recognize the object from the image processing apparatus 100, the lighting switch 160 radiates the light to the object. The lighting switch 160 is turned off according to the light controller 150 after a predetermined time. In an exemplary embodiment of the present disclosure, the lighting switch 160 is exemplified as an infrared light, but this disclosure is not limited thereto.

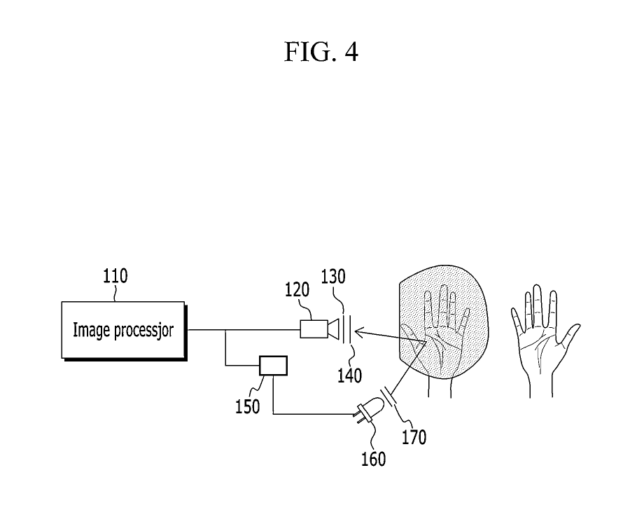

An exemplary embodiment of the image processing apparatus 100 will be described with reference to FIG. 4.

FIG. 4 shows an image processing apparatus according to an exemplary embodiment of the present disclosure. As shown in FIG. 4, the image processor 110 is connected to the image collector 120 of a two-dimensional camera and the infrared light lighting controller 150, and the infrared light lighting switch 160 is connected to the light controller 150. The lighting switch 160 radiates infrared rays to the object, and as the first diffuser 170 is disposed to the lighting switch 160, infrared rays evenly spread to the object.

The image collector 120 collects an image reflected from the object, and it is possible to collect a high resolution image which is blurred outside of the recognition region through the filter 130 and the second diffuser 140 installed to the image collector 120.

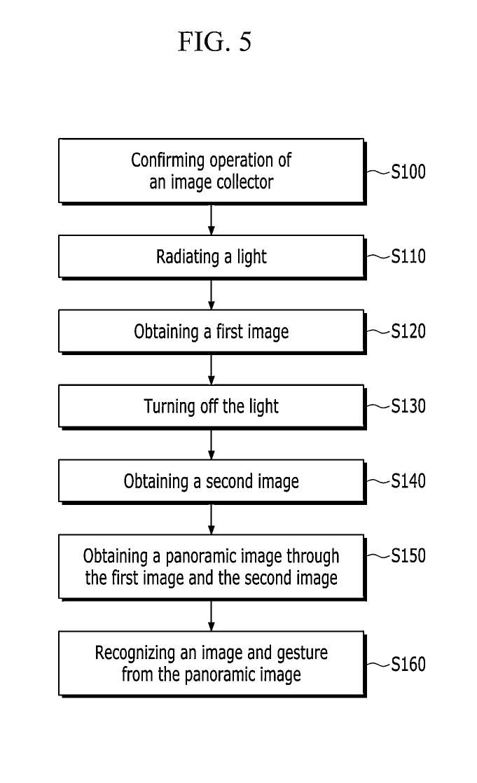

An image processing method for optically extracting a panoramic image without a complex image process through the image processing apparatus 100 as described above will be described with reference to FIG. 5.

FIG. 5 shows a flowchart of an image processing method according to an exemplary embodiment of the present disclosure. As shown in FIG. 5, when the image processor 110 confirms the operation of the image collector 120 at step S100, the image processor 110 generates a control signal of the lighting switch 160 and transmits the control signal to the lighting switch 160. The lighting switch 160 radiates light to the object at step S110 according to the image processor 110, and the image collector 120 acquires the first image from the object that the light is radiated.

Since the first diffuser 170 is installed to the lighting switch 160, the light radiated from the lighting switch 160 is evenly spread. The second diffuser 140 and the filter 130 are installed to the image collector 120, and thereby, the image collector 120 can acquire a high resolution image.

After the image collector 120 acquires the first image at step S120, the lighting switch 160 turns off the light according to control of the lighting controller 150. The image collector 120 acquires the second image of the object while the light is turned off.

The image processor 110 processes the first image and the second image acquired by the image collector 120 at steps S120 and S140, and thereby acquires the panoramic image. The image processor 110 recognizes an image or gesture of the object from the acquired panoramic image, and thereby corresponds to the image or gesture of the object.

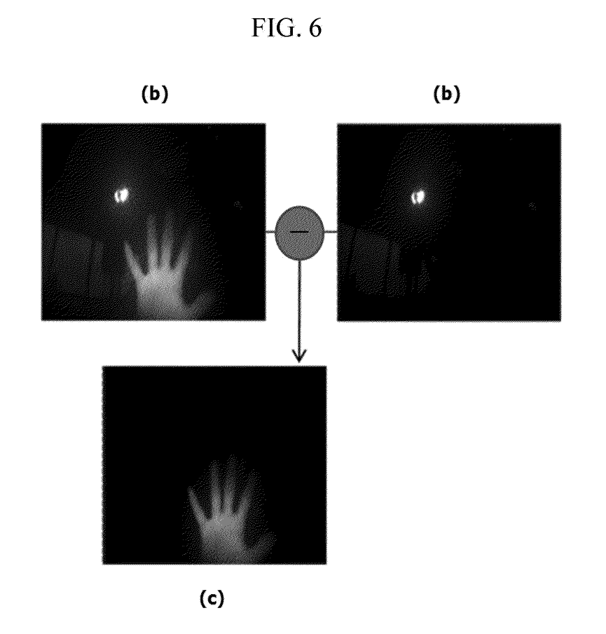

Here, the method of acquiring the panoramic image with the background image eliminated at step S160 will be described with reference to FIG. 6. FIG. 6 shows an exemplary view with the background image eliminated according to an exemplary embodiment of the present disclosure.

When the lighting switch 160 radiates light according to control of the light controller 150, the image collector 120 collects the first image as shown in FIG. 6. When the lighting switch 160 is turned off, the image collector 120 collects the second image as shown in FIG. 6. The first image includes the object and the background, and the second image includes only the background excluding the object to acquire.

When using the diffusers 140 and 170, a radiating region of the lighting switch 160 installed for recognizing the object and most of the background image outside of the input region are eliminated, or resolution of the radiating region and the most background image is decreased. Therefore, the background image is naturally eliminated. However, illuminating indoors or a self-radiating object is inputted to the image collector 120 and functions as noise.

Therefore, according to an exemplary embodiment of the present disclosure, the lighting controller 150 controls the illumination timing when the image collector 120 photographs and acquires the image. For example, according to an exemplary embodiment of the present disclosure, when an odd-numbered image is photographed, the first image is acquired while the illumination is turned on, and when an even numbered image is photographed, the second image is acquired while the illumination is turned off.

The image processor 110 detects a differential image by subtracting the second image from the first image. Accordingly, a reflective image due to a real internal illumination can be acquired. In the differential image, only the panoramic image (i.e., an image of the object) with extrinsic noise eliminated remains. The image processor 110 analyzes the panoramic image, obtains feature points of the panoramic image, and recognizes the image or gesture using the feature points

While this disclosure has been described in connection with what is presently considered to be practical exemplary embodiments, it is to be understood that the disclosure is not limited to the disclosed embodiments, but on the contrary, is intended to cover various modifications and equivalent arrangements included within the spirit and scope of the appended claims.

What is claimed is:

1. An image processing apparatus comprising:
a lighting switch turned on or off based on a control signal inputted from an outside thereof to selectively radiate a light to an object of a recognition target;
a first diffuser connected to the lighting switch and spreading the light radiated from the lighting switch to the object;
an image collector collecting a first image of the object in a turned-on state of the lighting switch and collecting a second image of the object in a turned-off state of the lighting switch; and
an image processor obtaining panoramic image by subtracting the second image from the first image, and thereby recognizing a gesture of the object.

2. The image processing apparatus of claim 1, further comprising:
a second diffuser installed to the image collector, receiving the light when the light is reflected from the object and eliminating an image existing at an outside of a recognition region of the image collector; and
a filter installed between the image collector and the second diffuser, and increasing resolution of the image decreased by the second diffuser.

3. The image processing apparatus of claim 2, further comprising a lighting controller controlling the lighting switch to be turned on or off based on the control signal generated by the image processor.

4. The image processing apparatus of claim 2, wherein the lighting switch emits an infrared light, and the filter is an infrared filter.

5. An image processing method by an image processing apparatus, comprising:
radiating light to a recognition object according to a control signal;
obtaining a first image of the object when the light is radiated to the object;
turning off the light according to the control signal and obtaining a second image of the object;
obtaining a panoramic image based on the first image and the second image; and
recognizing a gesture of the object from the obtained panoramic image.

6. The image processing method of claim 5, further comprising generating the control signal which controls the light before the light is irradiated to the object.

7. The image processing method of claim 5, wherein the panoramic image is obtained by eliminating the second image from the first image while obtaining the panoramic image.

8. The image processing method of claim 7, wherein the first image includes an image of the object and the background, and the second image includes only an image of the object.
